(19) United States
(12) Patent Application Publication
(10) Pub. No.: US 2014/0281864 A1
(43) Pub. Date: Sep. 18, 2014

(54) Method and Apparatus for Content Linkage and Sales Tracking

(71) Applicants: Scott Frankel, Los Angeles, CA (US); Greg Lam, Los Angeles, CA (US)

(72) Inventors: Scott Frankel, Los Angeles, CA (US); Greg Lam, Los Angeles, CA (US)

(21) Appl. No.: 13/837,524

(22) Filed: Mar. 15, 2013

(51) Int. Cl. G06F 17/22

(52) U.S. Cl. CPC G06F 17/2235
USPC 715/208

(57) ABSTRACT

A system includes a processor configured to receive a request to create a hyperlink, including selected text to be linked. The processor is also configured to provide a product display, including one or more selectable products to be associated with the hyperlink, responsive to the request. Additionally, the processor is configured to receive selection of at least one product to be associated with the hyperlink. Further, the processor is configured to create a hyperlink, the contents of which include capability to route a selecting user to a page for purchase of the product and a designator for tracking the selection of the link.

### TECHNICAL FIELD

The illustrative embodiments generally relate to a method and apparatus for content linkage and sales tracking.

### BACKGROUND

Internet content providers (i.e., online magazines, online newspapers, blogs, social networking sites, etc.) often derive a significant portion of their revenue from advertising sales on their site. Banner ads, pop-ups, dynamically generated advertising and numerous other forms of marketing revenue generators populate many sites across the Internet.

However, this advertising revenue by itself has not yet created a sustainable economic model for online content. Furthermore, with the simple premise of consumers visiting websites for its content and not its advertising efforts, new revenue channels can be created from the content itself.

### SUMMARY

In a first illustrative embodiment, a system includes a processor configured to receive a request to create a hyperlink, including selected text to be linked. The processor is also configured to provide a product display, including one or more selectable products to be associated with the hyperlink, responsive to the request. Additionally, the processor is configured to receive selection of at least one product to be associated with the hyperlink. Further, the processor is configured to create a hyperlink, the contents of which include capability to route a selecting user to a page for purchase of the product and a designator for tracking the selection of the link.

In a second illustrative embodiment, a computer-implemented method includes receiving a request to create a hyperlink, including selected text to be linked. The method further includes providing a product display, including one or more selectable products to be associated with the hyperlink, responsive to the request. Additionally, the method includes receiving selection of at least one product to be associated with the hyperlink. The method also includes creating a hyperlink, the contents of which include capability to route a selecting user to a page for purchase of the product and a designator for tracking the selection of the link.

In a third illustrative embodiment, a system includes a processor configured to receive a request to create a hyperlink, including selected text to be linked. The processor is also configured to provide a product display, including one or more selectable products to be associated with the hyperlink, responsive to the request. The processor is further configured to receive selection of at least one product to be associated with the hyperlink. Also, the processor is configured to create a database entry, including associations to a retailer of the product, a content provider and the product and create a hyperlink, including content usable to reference the database entry.

In a fourth illustrative embodiment, a computer-implemented method includes receiving a request to create a hyperlink, including selected text to be linked. The method also includes responsive to the request, providing a product display, including one or more selectable products to be associated with the hyperlink. Further, the method includes receiving selection of at least one product to be associated with the hyperlink. The method additionally includes creating a database entry, including associations to a retailer of the product, a content provider and the product and creating a hyperlink, including content usable to reference the database entry.

### BRIEF DESCRIPTION OF THE DRAWINGS

FIG. 1 shows an illustrative process for HyperText creation;

FIG. 2A shows an illustrative process for product selection;

FIG. 2B shows an illustrative example of a product selection screen; and

FIG. 3 shows an illustrative process for product provision upon link selection.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In the illustrative embodiments, HyperText links are created to provide an opportunity for a user to click on a link and be taken directly to a product website. In order for a content producer to manually create such a link, under an existing paradigm, the producer would have to endure several steps to locate and embed such link. After the link was embedded, it would correspond to a specified product within the content, that engages a tracking mechanism, so that the content producer received credit from the retailer for any purchases driven by the content provider's website.

The laborious steps to create a trackable text link under an existing paradigm are as follows: (1) The content producer would need to sign up for one of many independent affiliate marketplaces to gain access to their database of retail products. (2) Once a content producer was actively working with such affiliate marketplace(es), they would have to visit each marketplace, and keyword search for the product in question. (3) If such product was not found, said content producer would need to visit a secondary or tertiary affiliate marketplace to find the product in question. (4) Once the product in question was located, the content producer would need to copy the auto-generated, trackable product link and bring back to their website template to be pasted into the Content Management System or website template. (5) Finally, the content provider would need to embed such link to that product within their content page, which engages a tracking tool so that the provider received credit from the retailer for any purchases driven by the content provider's website.

Using the illustrative embodiments, this process is greatly simplified. When a content producer is done creating content, a simple plug-in application can be used in conjunction with a web-browser to create all linkages, link the text to specific products, and to ensure that tracking is performed and credit is given for all generated sales.

FIG. 1 shows an illustrative process for HyperText creation. In this illustrative example, a content provider will have created some portion of text that provides some reference to a product, or that the producer would otherwise like to associate with a specific product. For example, without limitation, the producer may have written an article about a skin exfoliation pad. While the article may be about the benefits and virtues of the product, it would be useful for the producer to also derive some revenue from any increased sales of this product that might be driven by the article.

Using the illustrative embodiment shown in FIG. 1, the content producer has the option to select some portion of text in the article about the product. In this example, the process is executed with a browser-plug-in, but it could also be a stand-alone software product, or in any other suitable form. The content provider selects the relevant text by blocking the text with a mouse and right clicking on the selected text. This provides a tool-tip menu (or similar), in which one of the options is to “create a HyperText” link. Selecting the option to create the HyperText link will cause the advanced functionality of the plug-in to engage.

The plug-in process shown in FIG. 1 receives the text to be changed into a hyperlink 101, as well as an instruction to cause the text to become HyperText 103, which is a monetized text link, pointing to a retail product page, within a retailer's website, and attributed back to the content producer that created the link. The plug-in is provided, in this example, by a third-party advertising provider. The advertising provider has, at its access, a vast database of products, manufacturers and retailers. In this example, the items stored in the database relate to inventory sold by retailers or manufacturers with whom the advertising provider has struck a deal for some form of revenue sharing or other payment upon sale generation.

When the instruction to create the HyperText is received, the plug-in can access this database to pull up a list of products that may be affiliated with the selected text or the search parameter(s) entered into the plug-in search fields. In at least one example, the text string can be parsed and likely retailers, manufacturers and/or product names can be pulled out of the text. For example, if the text that was to be linked was “Bliss That's Incredi-Peel Spa-Strength Glycolic Resurfacing Pads,” then there are a number of useful items of information within this text. The company name “Bliss” could be extracted and the process could recognize that Bliss had one or more products listed in the database. From these products, the product called “That's Incredi-Peel” could be noted, and thus, from the text, a specific product could be identified. Even if the company name were not discernable, the product name may match a product in the database, which could be sufficient for identification. Similarly, if the product name were not discernable (due to non-selection of the name, misspelling or mistyping of the name, or other issues, for example), the company name “Bliss” might produce a list of all Bliss products in the database.

In other examples, the content provider may have linked more generalized text, such as “new skin treatment pad.” When text such as this is linked, the process may provide a keyword search of the database for products that have “skin treatment,” “pad,” “treatment pad,” etc. associated therewith. While this may produce a longer list of products, it still should contain the desired result. Of course, it is possible that the text is even more vague, such as “this great new product.” For this reason, the illustrative embodiment also provides an opportunity to keyword search the database for any particular product desired. More discussion of the search opportunities is provided with respect to FIGS. 2A and 2B.

Once the database has been provided for the content producer 105, this process also provides a copy of the words to be turned into HyperText 105 and a list of identified products 109. If there are no identified products, the content producer may have to perform a database search in order to identify the product that should be associated with the text.

In at least one example, there may be multiple instances of a product shown. While the instances may all relate to the same product, the instances may relate to different retailers selling the product. Since different retailers may provide different sales incentives, it may be useful for the content provider to be able to associate the products with the link in a preferred order. The link will link to the primary product first, but if there is an issue with that retailer (out of stock, etc.), then the link can route to a secondary retailer.

Similarly, the primary product may be linked and then a number of similar products may also be linked. Again, if there is an issue with the primary link/retailer, the secondary products can be accessed.

The process receives selection of a product to be associated with the HyperText link 111. This will typically designate the primary product, and in some instances, only one product may be selected. If there are no other products (or retailers of the product, if retailer specific selection is enabled) to be selected 113, the process continues. Otherwise, continued selection can be made until the selection process is completed. If there are multiple selections associated with a link 115, the content provider may designate a primary selection 117. Otherwise, if only a single selection was made (or allowed), the process may associate that product with the text 119.

Once the product is associated with the text, and the text is published online, selection of the text will send a user to the purchase page for the product. The advertising provider can track both the clicks that route to the page and any purchases done as a result of the routing. Credit can also be provided to the content producer through the advertising provider.

FIG. 2A shows an illustrative process for product selection. In this illustrative example, the process for selecting a product or products to be associated with the HyperText is described in greater detail. Once the plug-in has been engaged to create HyperText from a portion of text in the content, the process launches a selection window (in this embodiment) 201. The selection window displays the text to be turned into HyperText 203, a search display 205 and a product display window 207.

In at least one example, the search window may be subdivided into several categories. For example, it may be the case that a large online retailer, such as Amazon, has an agreement to provide certain revenues for sales generated. Since it might be difficult, if not impossible, for the advertiser to record and track every item for sale on Amazon, there may be additional search windows to search such large retailers. On the other hand, Amazon may pay less for a particular sale than another retailer. Accordingly, the producer could search the retailers listed in the advertising provider's database and, if the product is not found, then proceed to search the large retailer websites such as Amazon, all through the search screen.

The content producer can select which search (if there are multiple options) to be utilized if a search is desired 209. The parameters for the search can then be entered. These include, but are not limited to, product name, manufacturer, retailer, UPC, SKU, product ID, etc. Using the entered information, the search function attempts to find one or more instances of the product 213. If the requested product is found 215 (or if the product had already been discovered and no search was needed) the process displays information about the product(s) 211. Otherwise, the user will be alerted and 217 and a new search can be performed.

FIG. 2B shows an illustrative example of a selection display window. In this illustrative example, the selection window displays, among other things, the phrase selected by the editor for hyperlinking 223. Also, the process displays a search window which contains tabs corresponding to both the main database 225 and a secondary retailer 227 if the secondary retailer option is to be made available. In some instances, only the main database is available. Provided in the search screen are additional search options. In this non-limiting example, the content provider can search by retailer 229, manufacturer 231, brand 233, product name 235, upc 237 and sku 239. Other suitable search options could also be provided. Once the desired information has been entered into the search window, the content provider can use the information to search the database for the product.

Product search results may be displayed in the product display window. This can include, but is not limited to, an image of the product 241, the name of the product 243, the price of the product 245, any commission information related to selling the product 247, a retailer name 249, etc.

If the product is the correct product, the content producer can select an “add” button 251 to create the association between the product and the text to be linked. If more than one product is to be selected, the product display may also have a ranking window 253 in which a product ranking can be entered. Once selection and any ranking of the product (if desired) is completed, the process can create the link. Once the link is created, it is embedded in the content web-page for later selection by a user. The link will provide both a link to the associated product, for purchase, and will include some designation for allowing the third party advertisement provider to track selection of the link.

In some instances, when a user creates the hyperlink including the association, the link itself may contain the necessary information relating to the product IDs, content provider, retailer, etc. By clicking on the link, the third party advertising provider may be notified (through information contained in the link) of the relevant click, content provider, etc. This information can be used to track the click and any subsequent purchase. If there were multiple products associated with the link, the click can cause the third party provider to provide a secondary service, routing the link to the appropriate end destination based on suitable criteria.

In another example, creation of the link creates a database entry in the third party advertising provider's database. This entry can include all the necessary designations to track the link and provide the appropriate content. Multiple product associations can also be stored here, as well as any additional information needed. Clicking the link will notify the third party provider of the requested site, and the appropriate data can be pulled and routing provided accordingly. Other suitable methods of linking and tracking can also be used as desired.

The database entry in the system may be attributed to the content creator and the retailer so that tracking can be provided. In one illustrative example, when the link is selected, a routing server provided by the advertising provider routes the user to the appropriate purchase page. The routing, however, may or may not include information about where the link originated (i.e., the content provider). When a HyperText link is created, thus creating a corresponding database entry, and a user clicks on a HyperText link on the content producer's page, the link is redirected to the advertiser's servers. These servers are connected to the associated product within the database, re-assigned an outbound anonymized URL and then direct the user to the retail product page. In this manner, the retailer/brand is unable to directly identify the source of the originating link (esquire.com, for example), but the sale is still attributed back to the referring publisher, based on the new outbound UR and a correspondence within the advertising provider's database.

FIG. 3 shows an illustrative process for product provision upon link selection. As users browse the web pages created by the content creator, they will discover various links that provide access to the retail products. If the user wishes to purchase a product or view a product purchase page, clicking on the link will take the user to the corresponding page.

In this example, the link takes the user through a tracking portal maintained by the advertising provider. The link routes the user to a redirect portal, where the initial click can be tracked 303. Further, the primary link associated with the product can then be accessed, so that the user can be routed to the retailer for purchase of the particular product 305.

The process could complete here, with additional tracking provided, if desired, to track actual purchases of the product utilizing known tracking methods. Without limitation, one known tracking method is to embed code on a retailer's confirmation page that looks for purchases associated with the third party advertiser. When such a purchase is made, the code tracks the relevant information from the purchase and relays the information to the third party advertiser for tracking purposes. In this example, however, a secondary measure is taken to check inventory levels of a particular product with respect to a retailer.

If there are one or more of the actual product available at the retailer's website 307, the process will route the user to the website. This website will initially correspond to the primary product or retailer associated with the link, if there are more than one products or retailers associated with the link.

If the primary product is not available or the primary retailer is out of inventory, the process will check to see if there are secondary products or retailers associated with the link 311. If there are not, then the process will route to the primary retailer site, where the product may be able to be back-ordered, for example.

If there are secondary products or retailers associated with the link, then the process may check one or more of the secondary retailers to see if the product is available the retailer. Additionally or alternatively, the process may check one or more secondary products to see if those secondary products are available. Which products and retailers to check first in this instance may be designated by additional rankings, could be random, or can be determined by any suitable method.

If there are not any of the secondary products/retailers available, then the primary product may again be shown. On the other hand, if there are secondary sources for the product or secondary products available, the process may instead display these products for purchase.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive a request to create a hyperlink, including selected text to be linked;
responsive to the request, provide a product display, including one or more selectable products to be associated with the hyperlink;
receive selection of at least one product to be associated with the hyperlink; and
create a hyperlink, the contents of which include capability to route a selecting user to a page for purchase of the product and a designator for tracking the selection of the link.

2. The system of claim 1, wherein the product display includes an image of the product.

3. The system of claim 1, wherein the processor is further configured to:
receive selection of a plurality of products to be associated with the hyperlink;
receive ranking of the items providing at least a distinction between a primary product and secondary products; and
create an association between the hyperlink and the products that includes the distinction defined by the ranking.

4. The system of claim 3, wherein the primary product and at least one secondary product are different products.

5. The system of claim 3, wherein the primary product and at least one secondary product are the same product but are sold by different retailers.

6. A system comprising:
a processor configured to:
receive a request to create a hyperlink, including selected text to be linked;
responsive to the request, provide a product display, including one or more selectable products to be associated with the hyperlink;
receive selection of at least one product to be associated with the hyperlink;
create a database entry, including associations to a retailer of the product, a content provider and the product; and
create a hyperlink, including content usable to reference the database entry.

7. The system of claim 6, wherein the product display includes an image of the product.

8. The system of claim 6, wherein the processor is further configured to:
receive selection of a plurality of products to be associated with the hyperlink;
receive ranking of the items providing at least a distinction between a primary product and secondary products; and
create the database entry additionally including associations to the plurality of products and the rankings.

9. The system of claim 8, wherein the primary product and at least one secondary product are different products.

10. The system of claim 8, wherein the primary product and at least one secondary product are the same product but are sold by different retailers.

11. A computer-implemented method comprising:
receiving a request to create a hyperlink, including selected text to be linked;
responsive to the request, providing a product display, including one or more selectable products to be associated with the hyperlink;
receiving selection of at least one product to be associated with the hyperlink; and
creating a hyperlink, the contents of which include capability to route a selecting user to a page for purchase of the product and a designator for tracking the selection of the link.

12. The method of claim 11, wherein the product display includes an image of the product.

13. The method of claim 11, further comprising:
receiving selection of a plurality of products to be associated with the hyperlink;
receiving ranking of the items providing at least a distinction between a primary product and secondary products; and
creating an association between the hyperlink and the products that includes the distinction defined by the ranking.

14. The method of claim 13, wherein the primary product and at least one secondary product are different products.

15. The method of claim 13, wherein the primary product and at least one secondary product are the same product but are sold by different retailers.

16. A computer-implemented method comprising:
receiving a request to create a hyperlink, including selected text to be linked;
responsive to the request, providing a product display, including one or more selectable products to be associated with the hyperlink;
receiving selection of at least one product to be associated with the hyperlink;
creating a database entry, including associations to a retailer of the product, a content provider and the product; and
creating a hyperlink, including content usable to reference the database entry.

17. The method of claim 16, wherein the product display includes an image of the product

18. The method of claim 16, wherein the product display includes an image of the product.

19. The method of claim 16, further comprising:
receive selection of a plurality of products to be associated with the hyperlink;
receive ranking of the items providing at least a distinction between a primary product and secondary products; and
create the database entry additionally including associations to the plurality of products and the rankings.

20. The method of claim 18, wherein the primary product and at least one secondary product are different products.

21. The method of claim 18, wherein the primary product and at least one secondary product are the same product but are sold by different retailers.
